(19) United States
(12) Patent Application Publication
(10) Pub. No.: US 2013/0165306 A1
(43) Pub. Date: Jun. 27, 2013

(54) FORMER SHOULDER

(71) Applicant: TNA Australia Pty Limited, Lidcombe (AU)

(72) Inventor: Marek GRUS, Lidcombe (AU)

(73) Assignee: TNA Australia Pty Limited, Lidcombe (AU)

(21) Appl. No.: 13/705,038

(22) Filed: Dec. 4, 2012

(30) Foreign Application Priority Data
Dec. 5, 2011 (AU) 2011905059

(51) Int. Cl. B31D 5/00

(52) U.S. Cl. CPC B31D 5/0086
USPC 493/269

(57) ABSTRACT

A former assembly (10) for a packaging machine. The former assembly (10) includes a base (11) to which there is attached a frame (12) that supports a sleeve (13). The sleeve (13) encloses a generally upwardly extending passage (14) to which product is delivered in batches. The sleeve (13) is fixed to a former shoulder (15) having an external former surface (16) to which strip film material is delivered to be formed into a tubular configuration to receive the product.

### FIELD

The present invention relates to former shoulders employed in the packaging industry to deliver tubular bag material to packaging machines which form bags of product.

### BACKGROUND OF THE INVENTION

Packaging machines receive bag material in tubular form. Product to be packaged is delivered to the interior of the tubular bag material, with the packaging machine then transversely sealing and cutting the tubular bag material to form bags of product. The tubular bag material is formed by a former shoulder, to which packaging film is delivered in strip form. Formers and packaging machines are described in U.S. Pat. Nos. 4,910,943, 5,622,032, 4,663,917, 6,655,110, 7,159,376, 7,600,630, 7,383,672, 4,753,336, 7,124,559, 7,415,809, 7,152,387 and 7,472,528.

The tubular material provided by the former shoulder is longitudinally sealed. This function is performed by heating the tubular bag material along its longitudinally overlapping edges and by applying pressure to the overlapping longitudinal edges.

Located above the former is a weighing machine that delivers batches of product to a sleeve that extends to the former, with an internal sleeve extending from the central opening of the former to a position adjacent or below the lower edge of the former.

The tubular bag material passes the former, is longitudinally sealed and then delivered to the packaging machine. While this is occurring batches of product are delivered to the interior of the tubular bag material by the weigher, the batches consisting of product scattered along a length of the tubular bag material.

The disadvantage of the above discussed machines is that due to the length of each batch over which the product is distributed, the packaging machine is limited in respect of the number of bags it can produce per minute. Typically packaging machines cannot produce more than about 120 to 150 bags a minute.

In the packaging of snack foods there is now developed a market for small bags of snack foods that are again packaged within a larger bag. Accordingly a larger number of bags need to be produced. This entails not only additional machines but additional factories and/or factory size.

### OBJECT

It is the object of the present invention to overcome or substantially ameliorate at least one of the above disadvantages.

### SUMMARY

There is disclosed herein a former shoulder for a packaging machine, the former shoulder being configured to receive a strip of film bag material to configure the bag material into a tubular configuration, the shoulder having a generally upright longitudinal central axis and including:
an external former surface over which the bag material is to pass to be configured into the tubular configuration, with the external surface surrounding an aperture via which product is delivered into the tubular bag material, with the axis passing through the aperture and the aperture being inclined to the axis;
a former lip surrounding the aperture so as to provide a lower lip portion located most remote from the axis; and
an internal sleeve extending downwardly from the lip, the sleeve having a longitudinal length generally parallel to said axis, with the sleeve terminating above said lower lip portion.

Preferably, the lower lip portion includes a lower most extremity with the sleeve terminating above said extremity.

There is further disclosed herein a former shoulder for a packaging machine, the former shoulder being configured to receive a strip of film bag material to configure the bag material into a tubular configuration, the shoulder having a generally upright longitudinal central axis and including:
an external former surface over which the bag material is to pass to be configured into the tubular configuration, with the external surface surrounding an aperture via which product is delivered into the tubular bag material, with the axis passing through the aperture and the aperture being inclined to the axis so as to have an aperture lower extremity;
a former lip surrounding the aperture; and
an internal projection extending downwardly from the lip and having a surface to be positioned adjacent the bag material, and wherein the surface has an area that is less than that of the surface if projected below said extremity.

Preferably, the projection is a sleeve.

Preferably, said aperture has a height parallel to said axis, and said sleeve extends less than half the said height.

In an alternative preferred form, said shoulder does not have said projection (sleeve).

A former assembly including the above shoulder and supporting frame configured to support the shoulder.

### BRIEF DESCRIPTION OF THE DRAWINGS

A preferred form of the present invention will now be described by way of example with reference to the accompanying drawings wherein:

FIG. 1 is a schematic isometric view of a former assembly and a drive to engage tubular bag material to pull the bag material past the former assembly;

FIG. 2 is schematic side elevation of the former assembly and drive of FIG. 1;

FIG. 3 is a schematic isometric view of a former shoulder employed in the former assembly of FIGS. 1 and 2;

FIG. 4 is a schematic side elevation of the former shoulder of FIG. 3;

FIG. 5 is a schematic isometric view of a modification of the former shoulder of FIG. 3;

FIG. 6 is a schematic side elevation of the former shoulder of FIG. 5;

FIG. 7 is a schematic isometric view of a modification of the former shoulder of FIG. 3; and

FIG. 8 is a schematic side elevation of the former shoulder of FIG. 7.

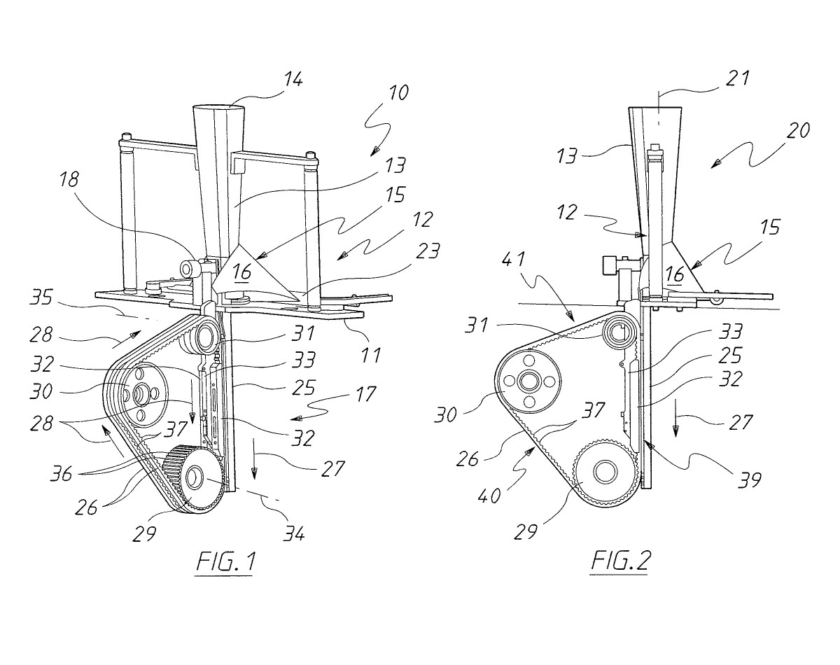

### DETAILED DESCRIPTION OF THE PREFERRED EMBODIMENTS

In the accompanying drawings there is schematically depicted a former assembly 10. The former assembly 10 may be similar to the former assemblies as disclosed in U.S. Pat. Nos. 7,12,459 and 7,415,809.

The former assembly 10 includes a base 11 to which there is attached a frame 12 that supports a sleeve 13. The sleeve 13 encloses a generally upwardly extending passage 14 to which product is delivered in batches from a weighing machine such as that disclosed in U.S. Pat. No. 7,600,630 and European Patent Application 082909573. The sleeve 13 is fixed to a former shoulder 15 having an external former surface 16 to which strip film material is delivered to be formed into a tubular configuration. Product is delivered to the passage 14 to be delivered to the interior of the tubular bag material. A packaging machine, such as that disclosed in U.S. Pat. No. 4,753,336, positioned below the drive assembly 17 transversely seals and cuts the bag material to form bags of product.

The former assembly 12 may include ducting 18 to deliver an inert gas to the interior of the tubular bag material.

Several embodiments of former shoulder 15 are more fully depicted in FIGS. 3 to 8. The shoulder 15 of this embodiment has the external surface 16 surrounding a generally central circular aperture 18 via which product is delivered to the interior of the tubular bag material. The sleeve 13 extends to the aperture 18. An internal cavity 19 of the shoulder 15 is surrounded by the internal surface 20 of the shoulder 15.

In the above described preferred embodiment, the aperture 18 is generally circular. However in other embodiments, the aperture 18 may be generally square or rectangular, depending on the configuration of the bag being formed.

The shoulder 15 is formed from of sheet metal, preferably stainless steel, bent around a generally central upright longitudinal axis 21, with the sheet terminating at a folded rear edge 22. The rear edge 22 is secured to a transverse member 23 of the frame 12. The axis 21 is the central axis of the aperture 18.

In FIGS. 3 to 8, there is schematically depicted three modifications of the former shoulder 15.

The aperture 18 is located in a curved plane that intersects the axis 21 at an acute angle, and is transverse of and inclined to the axis 21.

The sheet metal, bent to form the shoulder 15 is provided with a lip 24 that surrounds the aperture 18 and lies in the abovementioned plane. The lip 24 extends downwardly from an upper lip portion 38 to a lower lip portion 39. The lower lip portion 39 being the lower part of the lip 24 most remote from the axis 21, that is having the greatest radius from the axis 21. The portion 39 has a lower most extremity 46 located lower than the lowest part of the sleeve 40.

In the embodiments of FIGS. 5 to 8, the former shoulder 15 includes an internal projection 47 that extends downwardly from the lip 24 and is adjacent the bag material. In the embodiment the projection 47 is a sleeve 40. The sleeve 40 is generally tubular and has as its longitudinal axis the axis 21. The sleeve 40 is secured to and extends downwardly from the lip 24 and terminates at a lower edge 41. The lower edge 41 is located above the lower lip portion 39. Typically the sleeve 40 would be formed of sheet metal and welded to the internal surface 20 and projecting internally of the cavity 19.

The lower edge 14 terminates above the lower lip portion 39 by a length 42.

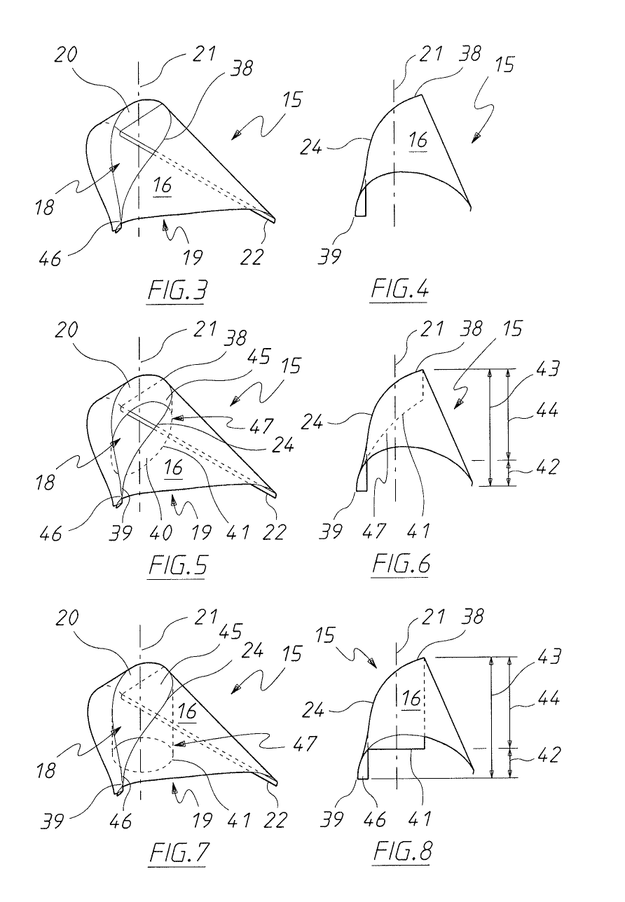

In the embodiment of FIGS. 3 and 4, the sleeve 40 has been eliminated.

As the aperture 18 extends transversely across the axis 21 and is generally inclined thereto, the aperture 18 will have an aperture height 43 in the direction of the axis 21.

The sleeve 40 has a height 44 in the direction of the axis 21.

The sleeve 40 has a lower edge. In the embodiment of FIG. 5, this lower edge is inclined to the axis 21. In the embodiment of FIG. 7, this lower edge is perpendicular to the axis 21.

In the above discussed previous former assemblies, the sleeve 40 projects beyond the lower lip portion 39. The tubular bag material passes down through the aperture 18 and is located adjacent the internal surface of the sleeve 40. It has been found that product being delivered to the interior of the tubular bag material, as it passes the lip 24, can impact against the tubular bag material but is restricted from further movement due to the sleeve 40 holding the tubular bag material in position and preventing it from flexing radially outward relative to the axis 21. This impacting against the tubular bag material causes the product, that is arranged in batches, to stretch over a longitudinal length. By terminating the sleeve 40 above the lower lip portion 39, and in particular removing the sleeve 40, it has been found that product impacting against the tubular bag material causes deflection of the tubular bag material which in turn minimises the longitudinal length of each batch of product. That is, there is less “rebound” of the product as the bag material deforms as opposed to not deforming when engaged by the sleeve 40. By minimising the length of each batch, the packaging machine below can operate at higher speeds, thereby enabling the machine to produce more bags per minute.

Fixed to so as to be supported by the frame 12 is a backing bar 25. The backing bar 25 is located internally of the tubular bag material so that the tubular bag material is located between the backing bar 25 and the drive belts 26. The backing bar 25 may include a heater so that the overlapping longitudinally extending edge portions of the tubular bag material are heated thereby.

The belts 26 engage the tubular bag material and cause the tubular bag material to pass downwardly in the direction 27 past the former shoulder 15 for delivery to a packaging machine below the assembly 17. The packaging machine may be a packaging machine as disclosed in U.S. Pat. No. 4,753,336.

The belts 26 are driven in the direction 28 by means of a drive pulley 29. The pulley 29 would be connected via shaft to a drive motor. The belts 26 pass about idler pulleys 30 and 31, with the belts 26 passing between the pulleys 29 and 30 along a linear path parallel to the backing bar 25 and axis 21.

Located adjacent the backing bar 25 are vacuum manifolds 32 to which a vacuum is applied. The belts 26 have apertures (not illustrated) that communicate with the vacuum chambers provided by the manifolds 32, with the reduced air pressure being applied to one side of the tubular bag material to urge the tubular bag material into contact with the drive surfaces of the belts 36. The vacuum drive assemblies are shown in U.S. Pat. Nos. 7,124,559 and 4,910,943.

Located between the manifolds 32 is a heating bar 33 that is electrically heated to again aid in raising the temperature of the tubular bag material so that pressures applied to the tubular bag material by the bar 33 and backing bar 25 will cause the longitudinal edge portions of the tubular bag material to be fused so as to be sealingly connected. The bar 33 is urged toward the bar 25 by springs not illustrated.

To drive the belts 26, the pulley 29 is provided with a plurality of drive teeth 36 that engage teeth 37 on the drive surface of the belts 26.

An advantage of the above described drive assembly 10 is that the distance between the rotational axes 34 and 35 of the pulleys 29 and 31 is reduced relative to previous machines as it is no longer necessary for the tubular bag material to be heated over an extended length. To provide for this reduced distance between the axes 34 and 35 the further idler pulley 30 is required.

1. A former shoulder for a packaging machine, the former shoulder being configured to receive a strip of film bag material to configure the bag material into a tubular configuration, the shoulder having a generally upright longitudinal central axis and including:
an external former surface over which the bag material is to pass to be configured into the tubular configuration, with the external surface surrounding an aperture via which product is delivered into the tubular bag material, with the axis passing through the aperture and the aperture being inclined to the axis;
a former lip surrounding the aperture so as to provide a lower lip portion located most remote from the axis; and
an internal sleeve extending downwardly from the lip, the sleeve having a longitudinal length generally parallel to said axis, with the sleeve terminating above said lower lip portion.

2. The former shoulder of claim 1, wherein the lower lip portion includes a lower most extremity with the sleeve terminating above said extremity.

3. A former shoulder for a packaging machine, the former shoulder being configured to receive a strip of film bag material to configure the bag material into a tubular configuration, the shoulder having a generally upright longitudinal central axis and including:
an external former surface over which the bag material is to pass to be configured into the tubular configuration, with the external surface surrounding an aperture via which product is delivered into the tubular bag material, with the axis passing through the aperture and the aperture being inclined to the axis so as to have an aperture lower extremity;
a former lip surrounding the aperture; and
an internal projection extending downwardly from the lip and having a surface to be positioned adjacent the bag material, and wherein the surface has an area that is less than that of the surface if projected below said extremity.

4. The former shoulder of claim 3, wherein the projection is a sleeve.

5. The former shoulder of claim 4, wherein said aperture has a height parallel to said axis, and said sleeve extends less than half the said height.

6. The former shoulder of claim 4, wherein the shoulder does not have said projection (sleeve).

7. A former assembly including the former shoulder of claim 1 and supporting frame configured to support the shoulder.

8. A former assembly including the former shoulder of claim 6 and supporting frame configured to support the shoulder.

9. A former shoulder of claim 1, further:
an internal surface surrounding a cavity communicating with said aperture; and
a heater to heat the external surface to in turn heat bag material passing over the external surface.

10. The former should of claim 9, wherein the heater is fixed to the surfaces.

11. The former shoulder of claim 9, wherein the heater includes a first heater and a second heater, the heaters being located so that the aperture is located therebetween.

12. The former shoulder of claim 11, wherein each heater is fixed to the internal surface.

13. The former should of claim 12, wherein each heater is an electrical resistance heater to which electrical energy is delivered to cause the heater to heat the external surface.

14. The former shoulder of claim 13, wherein the shoulder has an upright longitudinal axis, and each heater has a longitudinal length and a transverse width, with the longitudinal length being greater than the transverse width, and with each heater extending longitudinally angularly about said axis.

15. The former shoulder of claim 14, wherein each heater is located so as to be positioned adjacent a portion of the external surface over which longitudinal edges of the tubular bag material are to pass.

16. The former shoulder of claim 15, wherein the heater includes a first heater and a second heater, the heaters being located so that the aperture is located therebetween where each heater being fixed to the internal surface.

17. The former shoulder claim 16, wherein each heater has a longitudinal length and a transverse width, with the longitudinal length being greater than the transverse width, and with each heater extending longitudinally angularly about said axis.

18. The former shoulder of claim 17, wherein each heater is located so as to be positioned adjacent a portion of the external surface over which longitudinal edges of the tubular bag material are to pass.

19. The former shoulder claim 18, wherein each heater has a longitudinal length and a transverse width, with the longitudinal length being greater than the transverse width, and with each heater extending longitudinally angularly about said axis, with each heater being located so as to be positioned adjacent a portion of the external surface over which longitudinal edges of the tubular bag material are to pass.
